(19) United States
(12) Patent Application Publication
(10) Pub. No.: US 2020/0042862 A1
(43) Pub. Date: Feb. 6, 2020

(54) RECOMMENDING A PHOTOGRAPHIC FILTER

(71) Applicant: Hewlett-Packard Development Company, L.P., Spring, TX (US)

(72) Inventor: Christian S Perone, Montreal (CA)

(73) Assignee: Hewlett-Packard Development Company, L.P., Spring, TX (US)

(21) Appl. No.: 16/603,268

(22) PCT Filed: Apr. 20, 2017
(86) PCT No.: PCT/US2017/028575

§ 371 Date: Oct. 7, 2019

(51) Int. Cl. G06N 3/04; G06N 3/08; G06F 16/535; G06F 16/56; G06K 9/46; G06K 9/62

(52) U.S. Cl. CPC G06N 3/04; G06N 3/08; G06F 16/535; G03B 11/00; G06K 9/46; G06K 9/6256; G06K 9/6253; G06F 16/56

(57) ABSTRACT

A system for recommending a photographic filter is described. The system includes an inference manager which extracts a feature vector from an input image, searches a database for a stored feature vector that is within a predetermined mathematical window of the feature vector in the database, identifies a photographic filter associated with the stored feature vector, and recommends the photographic filter.

### BACKGROUND

Images may be collected or adjusted using photographic filters to create different effects. Applications, such as Instagram and Twitter, may apply software filters to a user's personal photographs. Similarly, photographers may use glass filters, which attach to the front of the lens of a camera, to change a picture as it is collected. There are a large number of different photographic filters, each filter having a different effect on a photograph.

### DESCRIPTION OF THE DRAWINGS

Certain examples are described in the following detailed description and in reference to the drawings, in which:

FIG. 1 is a schematic diagram of a process for recommending a photographic filter in accordance with examples of the present techniques;

FIG. 2 is a block diagram of a system for recommending a photographic filter in accordance with examples of the present techniques;

FIG. 3 is a block diagram of a system for recommending a photographic filter in accordance with examples of the present techniques;

FIG. 4 is a block flow diagram of a method for recommending a photographic filter in accordance with examples of the present techniques;

FIG. 5 is a block flow diagram of a method for recommending a photographic filter in accordance with examples of the present techniques; and

FIG. 6 is a block diagram of a medium containing code to execute recommendation of a photographic filter in accordance with examples of the present techniques.

### DETAILED DESCRIPTION

Techniques for recommending a photographic filter are described herein. A photographic filter may modify an image as it is collected or processed. For example, a photographic filter may be an optical filter that attaches to the lens of a conventional camera. In digital photography, software filters may be applied either when collecting an image or during post-processing. The term photographic filter, as used herein, refers to both glass filters and software filters.

As discussed herein, a system for recommending a photographic filter may include a training process. During the training process, an input image may be captured. The input image may be collected or processed using a photographic filter. The input image may be described mathematically. The mathematical description of the input image and an identification of the photographic filter may be saved to a database. The system for recommending a photographic filter may also include an inference process.

At present, image processing systems may not recommend a photographic filter to a user. Given the large number of filters available, a user may employ a trial-and-error process to determine which filter to use to obtain a particular effect. The trial-and-error process takes time and consumes battery power.

The techniques described herein may reduce the need for the user to experiment with different photographic filters. Historical data and a model that extracts image features may be used to recommend a photographic filter. The model may learn from historical data which filters were applied to certain images. The techniques may provide better quality images, reduced experimentation time, and reduced battery consumption.

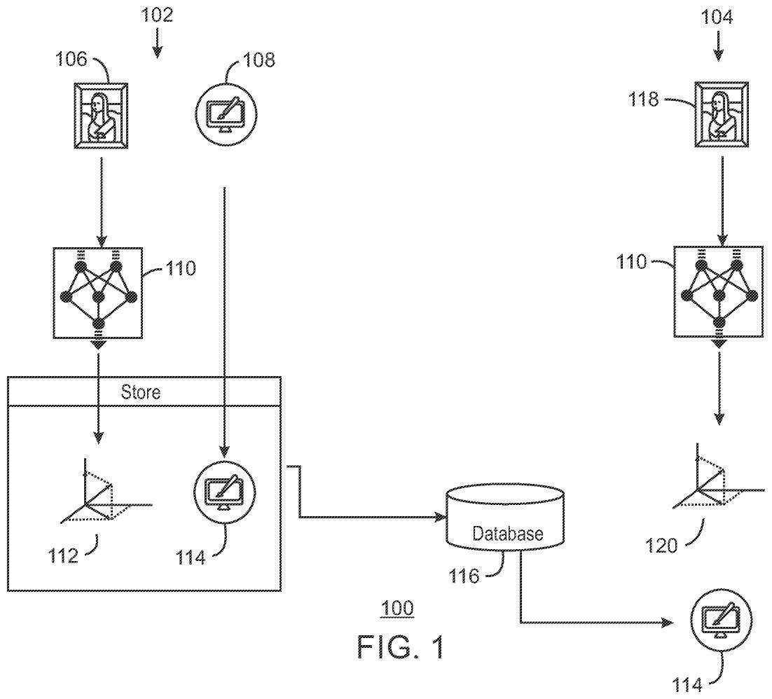

FIG. 1 is a schematic diagram of a process 100 for recommending a photographic filter. The process may involve two phases, a training phase 102 and an inference phase 104. During the training phase 102, the system may mathematically describe an input image and store the mathematical description in a database, alone with an identification of the photographic filter used to collect or process the input image. During the inference phase 104, a user may receive a recommendation for a filter to be used with a particular image.

During the training phase 102, the system may receive an input image 106. For example, the input image 106 may be captured using a conventional or digital camera or may be downloaded from a store of images. The input image 106 may have been collected or processed using a known photographic filter 108. For example, the user may have collected the image using a glass filter attached to the lens, or processed an image using a known software filter.

The user may apply a photographic filter 108 to the input image 106. For example, the user may attach a glass filter to the lens of a camera or the user may employ a software filter.

A model 110 may be used to extract a feature vector 112 from the input image 106. A feature vector 112 is an n-dimensional vector of numerical features, or values, that represent an object. When representing an image, the values may correspond to pixels of the input image 106. The values for a pixel may include values for intensity and color. The model 110 may be a relationship between an image 106 and the feature vector 112 that uses mathematical concepts.

The model 110 may be trained using a large number of images with identified filters, and any type of machine learning technique that uses data to model high level abstractions. An example of this type of machine learning may be deep learning. Examples of deep learning architectures may include neural networks, convolutional neural networks, belief networks, and recurrent neural networks. The model 110 may be trained using numerous natural image datasets. Natural image datasets may contain images falling into such categories as natural scenery, people, animals, and buildings. The filters used to capture the natural images may also be included in the datasets. This training of the model 110 may be in addition to the learning that occurs when an image is captured by a user and a feature vector 112 is extracted from the input image 106. The feature vector 112 may be associated with the photographic filter 108 that was used to capture or process the input image 106. The feature vector 112 and an identification 114 of the associated photographic filter 108 are stored in a database 116.

During the inference phase 104, a user may decide to apply a photographic filter to a new image, for example, to achieve a desired effect. The system may be used to identify a photographic filter that produces the desired effect. The initial steps of the inference phase 104 may be similar to the initial steps of the training phase 102. The model 110 trained during the training phase 102 may be used during the inference phase 104 to extract a feature vector 120 from the sample image 118. The feature vector 120 may be sent to the cloud as the inference phase 104 continues. The system may search the database 116 for a feature vector 112 similar to the feature vector 120 extracted from the sample image 118. The system may determine the identification 114 of a photographic filter associated with the feature vector 112 that is similar to the feature vector 120. Alternatively, the identifications of a number of photographic filters may be determined, ordered by similarity, and recommended to the user. Once a filter is identified, the user may use it to capture or process the new image, resulting in the desired effect.

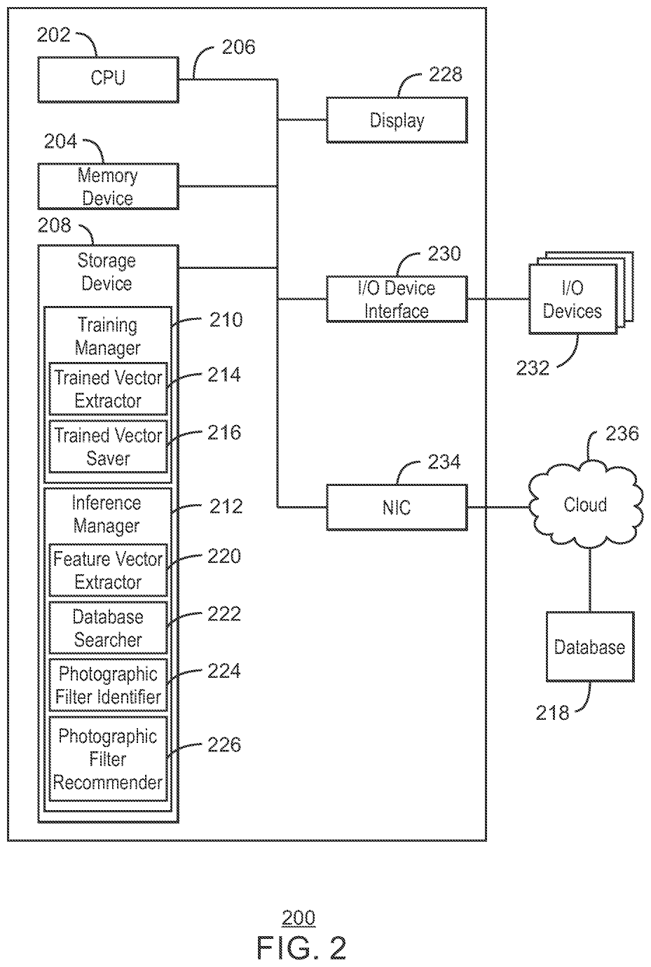

FIG. 2 is a block diagram of a system 200 for recommending a photographic filter. The system 200 may include a central processing unit (CPU) 202 for executing stored instructions. The CPU 202 may be more than one processor, and each processor may have more than one core. The CPU 202 may be a single core processor, a multi-core processor, a computing cluster, or other configurations. The CPU 202 may be a microprocessor, a processor emulated on programmable hardware, e.g. FPGA, or other type of hardware processor. The CPU 202 may be implemented as a complex instruction set computer (CISC) processor, a reduced instruction set computer (RISC) processor, an x86 instruction set compatible processor, or other microprocessor or processor.

The system 200 may include a memory device 204 that stores instructions that are executable by the CPU 202. The CPU 202 may be coupled to the memory device 204 by a bus 206. The memory device 204 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory system. The memory device 204 can be used to store data and computer-readable instructions that, when executed by the processor 202, direct the processor 202 to perform various operations in accordance with embodiments described herein.

The system 200 may also include a storage device 208. The storage device 208 may be a physical memory device such as a hard drive, an optical drive, a flash drive, an array of drives, or any combinations thereof. The storage device 208 may store data as well as programming code such as device drivers, software applications, operating systems, and the like. The programming code stored by the storage device 208 may be executed by the CPU 202.

The storage device 208 may include a training manager 210 and an inference manager 212. The training manager 210 may accomplish the tasks associated with the training phase 102 in FIG. 1, while the inference manager 212 may accomplish the tasks associated with the inference phase 104 in FIG. 1.

The training manager 210 may include a trained vector extractor 214. The trained vector extractor 214 may be a model that extracts a feature vector from an image. The model may be trained using any type of machine learning technique that uses data to model high level abstractions. An example of this type of machine learning may be deep learning. Examples of deep learning architectures that may be used include deep neural networks, convolutional deep neural networks, deep belief networks, and recurrent neural networks.

Deep learning methods may represent an image in a number of ways, including a vector of intensity and color values for each pixel, or in a more abstract way as a set of edges or regions of a particular shape. Input data that is too large to be processed and redundant in nature, such as an image composed of pixels, may be transformed into a reduced set of features called a feature vector. A feature vector is an n-dimensional vector of numerical features that represent an object. When representing an image, the feature values may correspond to the intensity and color of pixels in the training image.

The trained vector extractor 214 may use a deep learning model such as ResNet that was previously trained using numerous images from datasets such as ImageNet. Other models and image datasets may be used. In addition, the model may be trained as the trained vector extractor 214 extracts feature vectors from training images captured by the same or different users.

The training manager 210 may also include a trained vector saver 216. The trained vector saver 216 may save the extracted feature vector to a database 218. Along with the extracted feature vector, the trained vector saver 216 may save an identification of an associated photographic filter to the database 218. The associated photographic filter may have been used to obtain the training image in an image dataset. Alternatively, the associated photographic filter may have been chosen by a user who decided that the filter had a pleasing aesthetic effect on the training image captured by the user.

The inference manager 212 may include a feature vector extractor 220. The feature vector extractor 220 may extract a feature vector from an input image. The inference manager 212 may include a database searcher 222. The database searcher 222 may search the database 218 for one or more stored feature vectors that are similar to the feature vector extracted from the input image. For example, the feature vector may be within a predetermined mathematical window of the feature vector. A mathematical window is the degree of similarity between a feature vector and a stored feature vector. A feature vector and a stored feature vector may be deemed similar if a value in the feature vector is within a predetermined range of a value in a stored feature vector, such as 25%, 50%, 75%, 90%, or higher.

The inference manager 212 may include a photographic filter identifier 224. The photographic filter identifier 224 may identify the photographic filter associated with the stored feature vector that meets the quantified level of similarity with the feature vector extracted from the input image. The inference manager 212 may also include a photographic filter recommender 226 that recommends the photographic filter to a user.

The system 200 may also include a display 228. The display 228 may be a touchscreen built into the device. For example, the touchscreen may include a touch entry system. Alternatively, the display 228 may be an interface that couples to an external display. In this example, a human machine interface may couple to input devices, such as mice, keyboards, and the like. The display 228 may display the training image before and after the associated photographic filter is applied. In addition, the display 228 may list the photographic filters recommended by the system 200.

The system 200 may include an input/output (I/O) device interface 230 to connect the system 200 to one or more I/O devices 232. For example, the I/O devices 232 may include a scanner, a keyboard, and a pointing device such as a mouse, touchpad, or touchscreen, among others. The I/O devices 232 may be built-in components of the system 200, or may be devices that are externally connected to the system 200.

The system 200 may further include a network interface controller (NIC) 234 to provide a wired communication to the cloud 236. The cloud 236 may be in communication with the database 218. The system 200 may communicate with the database 218 via the NIC 234 and the cloud 236.

The block diagram of FIG. 2 is not intended to indicate that the system for recommending a photographic filter is to include all of the components shown. Rather, the system can include fewer or additional components not shown in FIG. 2, depending on the details of the specific implementation.

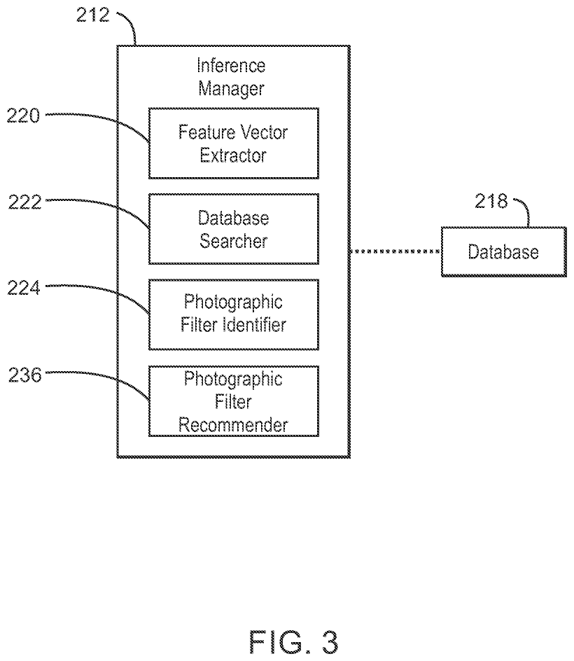

FIG. 3 is a block diagram of a system for recommending a photographic filter. The system may include an inference manager 212. The inference manager 212 may include a feature vector extractor 220, a database searcher 222, a photographic filter identifier 224, and a photographic filter recommender 226, which perform the same or similar functions as their counterparts in FIG. 2.

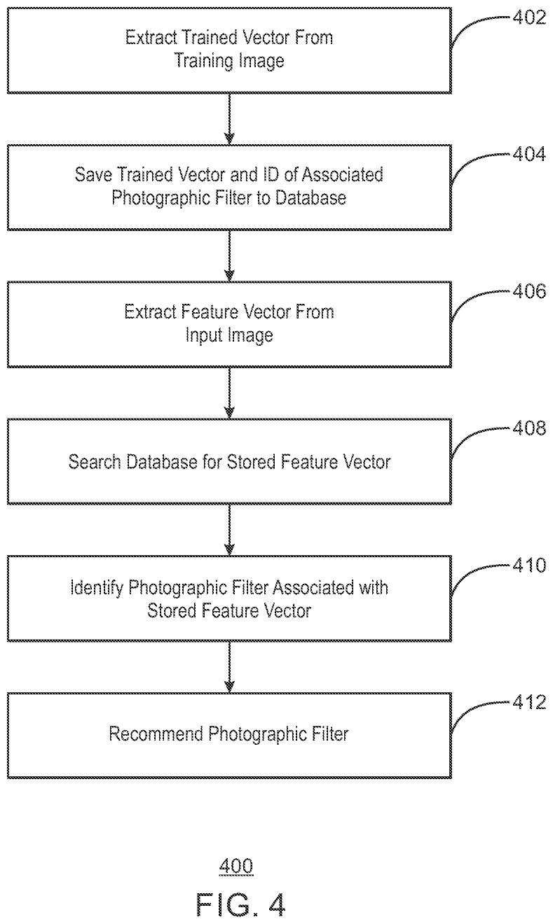

FIG. 4 is a block flow diagram of a method 400 for recommending a photographic filter. The method 400 may be performed by the systems shown in FIGS. 2 and 3. The method 400 may start at block 402 when a trained feature vector is extracted from a training image. The extracting may be accomplished by a model, such as a deep learning model. The deep learning model may have been previously trained using numerous image datasets. Multiple images that were taken or processed using the same photographic filter may be used to train for a single trained feature vector to lower the error.

At block 404, the trained feature vector and an identification of an associated photographic filter may be saved to a database. The associated photographic filter may have been applied to the training image when the training image was captured by a user. Alternatively, the associated photographic filter may have been used to capture an image in a dataset used to train the model.

At block 406, a feature vector may be extracted from an input image. The input image may be captured by a user. At block 408, a database may be searched for a stored feature vector. The database may be searched for a stored feature vector that is similar to the feature vector extracted from the input image. As described herein, the degree of similarity between a feature vector and a stored feature vector may be measured using a defined mathematical window. A feature vector and a stored feature vector may be deemed similar if a value in the feature vector is within a predetermined range of a value in a stored feature vector, such as 25%, 50%, 75%, 90%, or higher.

At block 410, a photographic filter associated with the stored feature vector may be identified. Each stored feature vector in the database may be associated with an identification for a photographic filter. In some examples, the photographic filter may have been used to process the images used for training.

At block 410, a photographic filter may be identified. In some examples, multiple photographic filters may be presented to the user, and ranked by similarity. At block 412, the photographic filter may be recommended to a user. If multiple filters are recommended, they may be presented to the user in ranked order.

The block flow diagram of FIG. 4 is not intended to indicate that the method is to include all of the blocks shown. Further, the method may include any number of additional blocks not shown in FIG. 4, depending on the details of the specific implementation.

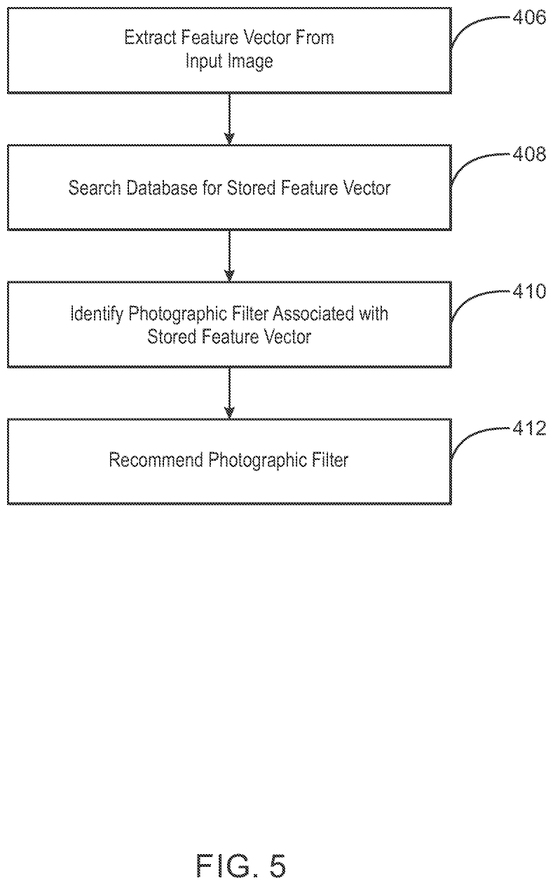

FIG. 5 is a block flow diagram of a method for recommending a photographic filter. Like numbered items are as described with respect to FIG. 4. Like the method 400 in FIG. 4, the method in FIG. 5 may be performed by the systems shown in FIGS. 2 and 3.

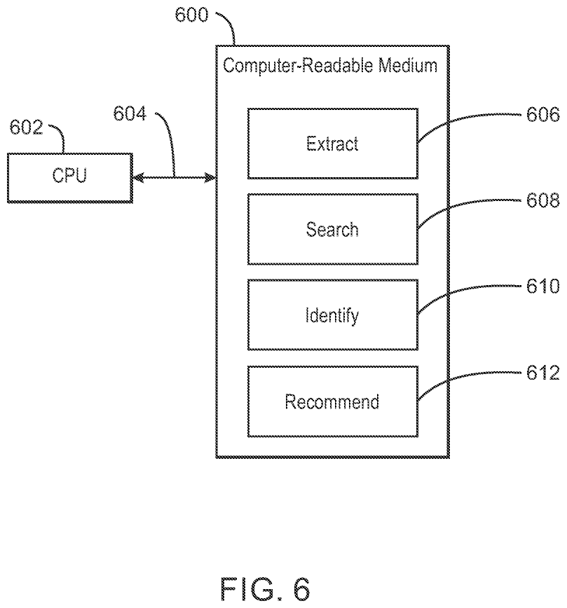

FIG. 6 is a block diagram of an exemplary non-transitory, machine-readable medium 600 including code to direct a processor 602 to recommend a photographic filter. The processor 602 may access the non-transitory, machine-readable medium 600 over a bus 604. The processor 602 and the bus 604 may be selected as described with respect to the processor 202 and the bus 206 of FIG. 2. The non-transitory, machine-readable medium 600 may include devices described for the mass storage 208 of FIG. 2, or may include optical disks, thumb drives, or any number of other hardware devices.

As described herein, the non-transitory, machine-readable medium 600 may include code 606 to direct the processor 602 to extract a feature vector from an input image. Code 608 may be included to direct the processor 602 to search a database for a stored feature vector that is within a predetermined mathematical window of the extracted feature vector. Code 610 may direct the processor 602 to identify a photographic filter associated with the stored feature vector. Code 612 may be included to direct the processor 602 to recommend a photographic filter to a user.

The block diagram of FIG. 6 is not intended to indicate that the medium 600 is to include all of the modules shown. Further, the medium 600 may include any number of additional modules not shown in FIG. 6, depending on the details of the specific implementation.

In summary, the techniques described herein may recommend photographic filters that were applied in the past to images having the same or similar characteristics to the new image a user wants to capture. By applying the techniques described herein, a user will be able to obtain aesthetically pleasing results by experimenting with fewer photographic filters because other users have recommended filters for use on the same or similar photographs. In addition to reduced experimentation time, the recommendation of photographic filters may also result in better quality images and decreased battery consumption.

Furthermore, the techniques described herein may reduce privacy concerns. A user's personal images are not sent to the cloud for storage in a database. Only the feature vectors extracted from the personal images are stored in the cloud. Moreover, the techniques presented herein probably will not result in communication bottlenecks. A feature vector is very small, usually having no more than 4,096 floating points. The size of a feature vector does not change with the image resolution; the size of the feature vector remains small regardless of the image resolution. Because of the small size of the feature vector, the amount of time and bandwidth required to transmit a feature vector is not significant. This is especially important for mobile devices which have data plans that are slow and expensive.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the scope of the present techniques.

What is claimed is:

1. A system for recommending a photographic filter, comprising an inference manager to:
extract a feature vector from an input image;
search a database for a stored feature vector that is within a predetermined mathematical window of the feature vector in the database; and
identify a photographic filter associated with the stored feature vector.

2. The system of claim 1, wherein the inference manager is to recommend the photographic filter.

3. The system of claim 1, comprising a training manager to:
extract a trained vector from a training image; and
save the trained vector and an identification of an associated photographic filter to the database, wherein the associated photographic filter is used to obtain the training image.

4. The system of claim 1, wherein the associated photographic filter is chosen by a user, and wherein the user captures the training image.

5. The system of claim 1, wherein a deep learning model extracts the feature vector from the input image.

6. The system of claim 5, wherein the deep learning model is trained using a natural image dataset.

7. A method for recommending a photographic filter, comprising:
extracting a feature vector from an input image;
searching a database for a stored feature vector that is within a predetermined mathematical window of the feature vector in the database;
identifying a photographic filter associated with the stored feature vector; and
recommending the photographic filter.

8. The method of claim 7, comprising:
extracting a trained vector from a training image; and
saving the trained vector and an identification of an associated photographic filter to the database, wherein the associated photographic filter is used to obtain the training image.

9. The method of claim 8, wherein the associated photographic filter is chosen by a user, wherein the user captures the training image.

10. The method of claim 8, comprising extracting the trained vector from the training image using a deep learning model.

11. The method of claim 10, comprising extracting the feature vector from the input image using the deep learning model.

12. The method of claim 10, comprising training the deep learning model using a natural image dataset.

13. A non-transitory, computer readable medium comprising machine-readable instructions for recommending a photographic filter, the instructions, when executed, direct a processor to:
extract a feature vector from an input image;
search a database for a stored feature vector that is within a predetermined mathematical window of the feature vector in the database;
identify a photographic filter associated with the stored feature vector; and
recommend the photographic filter.

14. The non-transitory, computer readable medium of claim 13, wherein the instructions when executed direct the processor to:
extract a trained vector from a training image; and
save the trained vector and an identification of an associated photographic filter to the database, wherein the associated photographic filter is used to obtain the training image.

15. The non-transitory, computer readable medium of claim 14, wherein the instructions when executed direct the processor to extract the trained vector from the training image using a deep learning model.
